(19) United States
(12) Patent Application Publication
(10) Pub. No.: US 2008/0172276 A1
(43) Pub. Date: Jul. 17, 2008

(54) APPARATUS, SYSTEM, AND METHOD FOR ASSESSING INFORMATION TECHNOLOGY ENVIRONMENT NEEDS

(76) Inventors: Mary C. Burton, Springfield, IL (US); Sandra K. Johnson, Austin, TX (US)

Correspondence Address: Brian C. Kunzler;Kunzler and Associates, Suite 600, 8 East Broadway, Salt Lake City, UT, 84111, US

(21) Appl. No.: 11/622,953

(22) Filed: Jan. 12, 2007

(51) Int. Cl. G06F 9/46

(52) U.S. Cl. 705/8

(57) ABSTRACT

An apparatus, system, and method are disclosed for assessing information technology environment needs. A survey module surveys an IT environment. A current profile module creates a current profile of the IT environment. A business need module identifies a business need for the IT environment. A model profile module creates a model profile for the business need. A recommendation module recommends a needed building block for the current profile from a comparison between the current profile and the model profile if the needed building block is available. A request module requests the development of the needed building block if the needed building block is not available.

### BACKGROUND OF THE INVENTION

1. Field of the Invention

This invention relates to assessing needs and more particularly relates to assessing information technology (IT) environment needs.

2. Description of the Related Art

IT environments are an important and integral part of many organizations. An IT environment may include servers, mainframe computers, routers, bridges, storage subsystems, and the like. An organization may use the IT environment to interact with customers through the Internet, store data, and perform many of the functions required by the organization's operations.

Organizations often must expand their IT environments to meet new business needs. An organization may expand its IT environment by adding new elements and software. Many organizations, particularly small- and medium-sized organizations, do not know which elements and software should be added to their IT environments in order to meet changing business needs.

Sales personnel for original equipment manufacturers, resellers, value-added partners, and the like may find it difficult to add hardware elements and software to an existing IT environment in order to meet a business need. For example, sales personnel may be unfamiliar with the capabilities and requirements of servers in a server farm. As a result, the sales personnel may be uncertain if the servers can fulfill a specified business need. In addition, the sales personnel may be unsure what additional hardware elements and software should be added to an existing IT environment to enable the IT environment to meet the business need.

### SUMMARY OF THE INVENTION

From the foregoing discussion, there is a need for an apparatus, system, and method that assess IT environment needs. Beneficially, such an apparatus, system, and method would allow sales personnel to recommend devices and software that may be added an existing IT environment to enable the IT environment to meet a business need.

The present invention has been developed in response to the present state of the art, and in particular, in response to the problems and needs in the art that have not yet been fully solved by currently available IT environment assessment methods. Accordingly, the present invention has been developed to provide an apparatus, system, and method for assessing IT environment needs that overcome many or all of the above-discussed shortcomings in the art.

The apparatus to assess IT environment needs is provided with a plurality of modules configured to functionally execute the steps of surveying an IT environment, creating a current profile, identifying a business need, creating a model profile, recommending a needed building block, and requesting the development of a needed building block in the case where one does not exist. These modules in the described embodiments include a survey module, a current profile module, a business need module, a model profile module, a recommendation module, and a request module.

The survey module surveys an IT environment. The current profile module creates a current profile of the IT environment. The current profile comprises at least one building block. In one embodiment, each building block is represented as a metadata keyword.

The business need module identifies a business need for the IT environment. The model profile module creates a model profile for the business need. The model profile comprises at least one building block.

The recommendation module recommends a needed building block for the current profile from a comparison between the current profile and the model profile if the needed building block is available. In addition, the request module requests the development of the needed building block if the needed building block is not available. The apparatus assesses the IT environment needs and recommends additional building blocks and/or the development of building blocks to meet the needs.

A system of the present invention is also presented to assess IT environment needs. The system may be embodied in an IT environment. In particular, the system, in one embodiment, includes an IT system and a computer. The computer includes a survey module, a current profile module, a business need module, a model profile module, a recommendation module, and a request module.

The computer is in communication with the IT system. The survey module surveys an IT environment for the IT system. The current profile module creates a current profile of the IT environment. The current profile comprises at least one building block. In one embodiment, each building block is represented as a metadata keyword.

The business need module identifies a business need for the IT environment. The model profile module creates a model profile for the business need. The model profile comprises at least one building block.

The recommendation module recommends a needed building block for the current profile from a comparison between the current profile and the model profile if the needed building block is available. In addition, the request module requests the development of the needed building block if the building block is not available. The system assesses and recommends additional building blocks and/or the development of building blocks to meet IT environment needs.

A method of the present invention is also presented for assessing IT environment needs. The method in the disclosed embodiments substantially includes the steps to carry out the functions presented above with respect to the operation of the described apparatus and system. In one embodiment, the method includes surveying an IT environment, creating a current profile, identifying a business need, creating a model profile, recommending a needed building block, and requesting the development of a needed building block.

A survey module surveys an IT environment. A current profile module creates a current profile of the IT environment. The current profile comprises at least one building block. A business need module identifies a business need for the IT environment. A model profile module creates a model profile for the business need. The model profile comprises at least one building block.

A recommendation module recommends a needed building block for the current profile from a comparison between the current profile and the model profile if the needed building block is available. A request module requests the development of the needed building block if the needed building block is not available. The method assesses the IT environment needs and recommends and/or requests building blocks to meet the assessed needs.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention assesses IT environment needs. In addition, the present invention recommends IT building blocks such as hardware, software, and the like to meet the assessed needs. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an IT environment in accordance with the present invention;

FIG. 2 is a schematic block diagram illustrating one embodiment of an assessment apparatus of the present invention;

FIG. 3 is a schematic flow chart diagram illustrating one embodiment of an assessment method of the present invention;

FIG. 4 is a schematic block diagram illustrating one embodiment of a current profile of the present invention;

FIG. 5 is a schematic block diagram illustrating one embodiment of a model profile of the present invention;

FIG. 6 is a schematic block diagram illustrating one embodiment of recommended building blocks of the present invention; and

FIG. 7 is a schematic block diagram illustrating one embodiment of requested building blocks of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

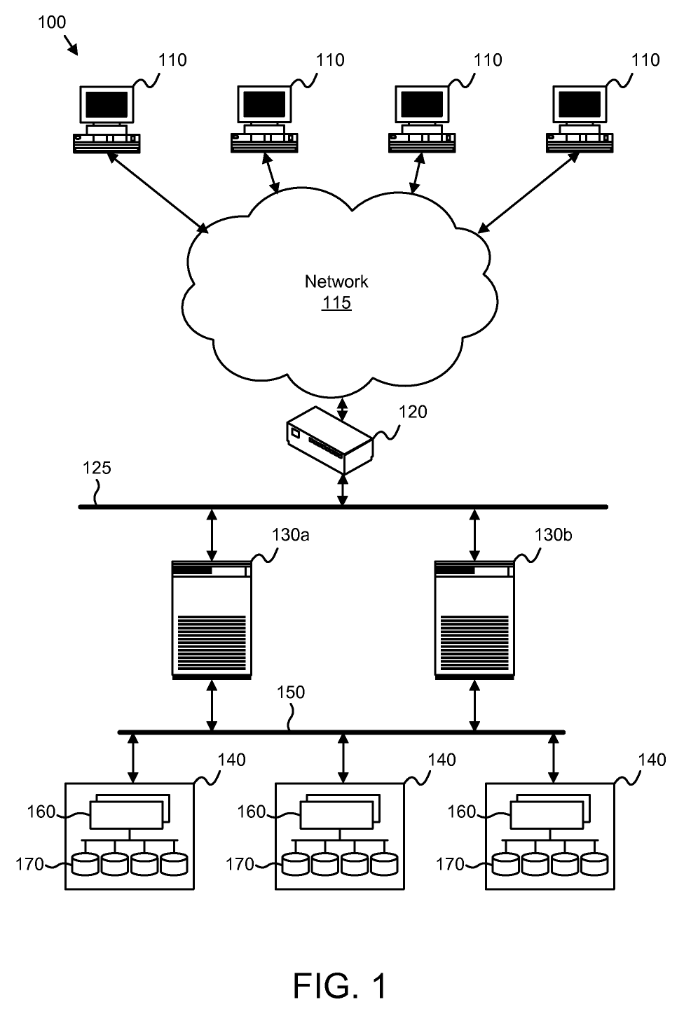

FIG. 1 is a schematic block diagram illustrating one embodiment of an IT environment 100 in accordance with the present invention. The IT environment 100 includes one or more clients 110, a network 115, a router 120, an internal network 125, one or more servers 130, a storage network 150, and one or more storage subsystems 140.

The storage subsystems 140 may store data for the clients 110 and the servers 130. In one embodiment, the storage subsystems 140 are configured as RAID systems. The storage subsystems 140 each include one or more storage controllers 160 and one or more storage devices 170. The storage devices 170 may be hard disk drivers, optical storage devices, micromechanical storage devices, holographic storage devices, magnetic tape drivers, and the like.

The servers 130 may perform computational tasks for the clients 110. For example, a server 130 may execute a database application for a client 110. In one embodiment, the servers 130 communicate with the clients 110 through the network 115, the router 120, and the internal network 125. The network 115 may be the Internet, a wide area network, a local area network, or the like. The internal network 125 may be a token ring network, an Ethernet network, or the like.

The servers 130 and clients 110 may store data on the storage subsystems 140. The servers 130 may communicate with the storage subsystems through the storage network 150. The storage network 150 may be Fibre Channel Loop, a small computer system interface (SCSI) network, or the like.

A customer may have the IT environment 100 installed in a data center. The customer may want the IT environment 100 to handle additional tasks. Sales personnel may wish to determine devices and software that may be added to the IT environment 100 so that the IT environment 100 may handle the additional tasks. The present invention assesses the needs of the IT environment as will be discussed hereafter. In addition, the present invention may recommend device and software building blocks that may be added to the IT 100 so that the IT environment is enabled to handle the additional tasks.

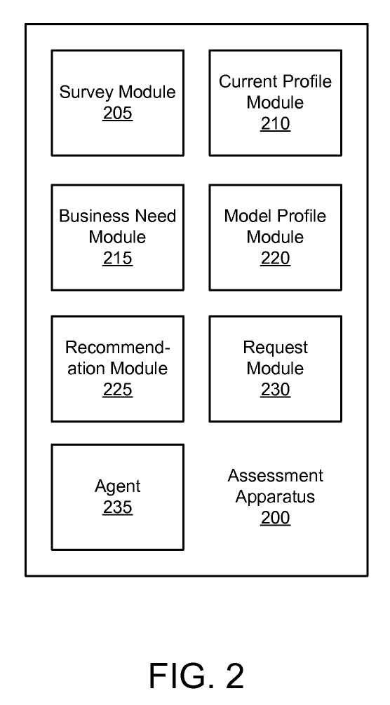

FIG. 2 is a schematic block diagram illustrating one embodiment of an assessment apparatus 200 of the present invention. The apparatus 200 may be embodied in a client 110. As depicted, the apparatus 200 includes a survey module 205, a current profile module 210, a business need module 215, a model profile module 220, a recommendation module 225, a request module 230, and an agent 235. The description of the apparatus 200 refers to elements of FIG. 1, like numbers referring to like elements.

In one embodiment, the survey module 205, current profile module 210, business need module 215, model profile module 220, recommendation module 225, and request module 230 may comprise one or more computer readable programs executing on the client 110. The agent 235 may comprise one or more computer readable programs executing on the client 110, a server 130, and the like.

The survey module 205 surveys the IT environment 100. In one embodiment, the survey module 205 uses the agent 235 to autonomously poll devices and software in the IT environment 100. For example, the agent may poll the storage subsystems 140 to determine a number and type of storage controllers 160, a number and capacity of storage devices 170, a software revision for the storage subsystem 140, and the like.

In one embodiment, the survey module 205 surveys the IT environment 100 by parsing sales data and service data for the IT environment 100. For example, the survey module 205 may parse sales data for a customer from a sales database to determine the devices and software that may be present in the customer's IT environment 100.

The current profile module 210 creates a current profile of the IT environment 100 from the results of the survey module's survey. The current profile comprises at least one building block as will be described hereafter. In one embodiment, each building block is represented as a metadata keyword. For example, a server 130 may be represented with the metadata keyword “SERV-A5.3” where “SERV” identifies the device as a server 130 and “A5.3” indicates that the server 130 is configured with version 5.3 of the AIX operating system produced by International Business Machines Corporation (IBM) of Armonk, N.Y.

The business need module 215 identifies a business need for the IT environment 100. In one embodiment, the business need module 215 comprises one or more data input screens that allow a customer and/or sales personnel to enter requirements, objectives, and preferences. The requirements, objectives, and preferences may be stored in a data set such as a linked array, a database, or the like. In a certain embodiment, the business need module 215 may employ an algorithm to generate the business need from the requirements, objectives, and preferences.

The model profile module 220 creates a model profile for the business need. The model profile comprises at least one building block. The building blocks of the model profile may be represented as metadata keywords. In one embodiment, the model profile module 220 may aggregate sales data for a plurality of IT environments that are designed for the business need to create the model profile. Alternatively, the model profile module 220 may incorporate market intelligence for products designed for the business need into the model profile.

The recommendation module 225 recommends a needed building block for the current profile. For example, the recommendation module 225 may compare the current profile with the model profile and recommend a building block of the model profile that is not in the current profile if the building block is available.

If a needed building block is not available, the request module 230 requests the development of the needed building block. The apparatus 200 assesses the IT environment needs and recommends additional building blocks and/or the development of building blocks to meet the needs.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

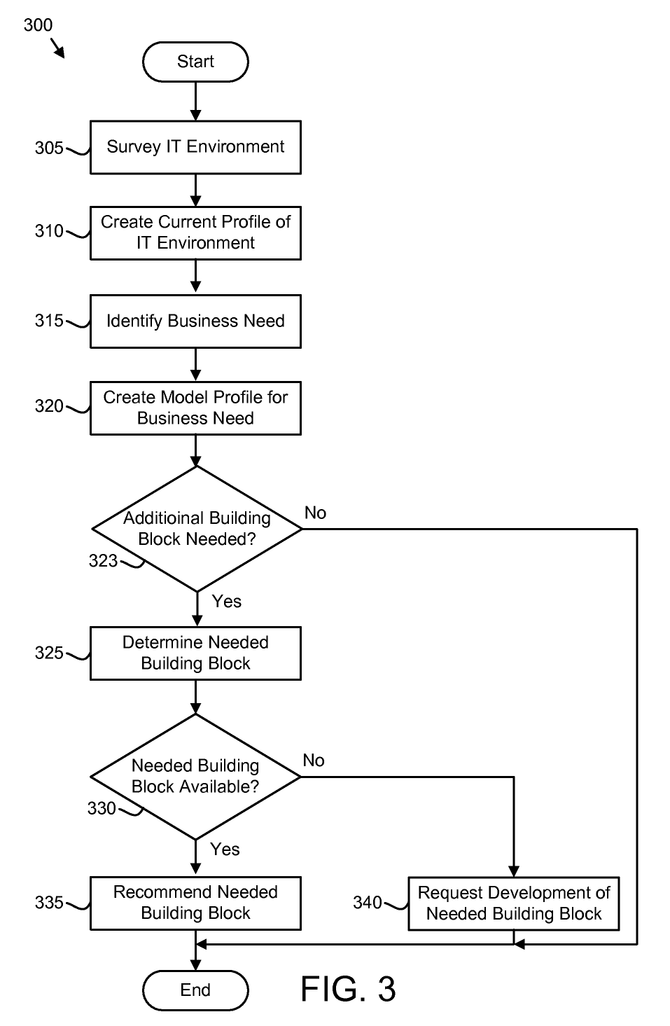

FIG. 3 is a schematic flow chart diagram illustrating one embodiment of an assessment method 300 of the present invention. The method 300 substantially includes the steps to carry out the functions presented above with respect to the operation of the described apparatus and system of FIGS. 1-2. The description of the method 300 refers to elements of FIGS. 1-2, like numbers referring to like elements.

In one embodiment, the method 300 is implemented with a computer program product comprising a computer readable medium having a computer readable program. The computer readable program may be executed by a client 110 and/or a server 130.

The method 300 begins and in one embodiment, the survey module 205 surveys 305 the IT environment 100. In one embodiment, the survey module 205 surveys 305 the IT environment 100 by receiving metadata keywords representing the IT environment 100. In one example, the survey module 205 receives metadata keyword selections corresponding to hardware and software elements in the IT environment 100 from the agent 235. In an alternate example, the survey module 205 may comprise one or more data input screens that receive metadata keyword selections from the sales personnel and/or the customer.

The current profile module 210 creates 310 a current profile of the IT environment 100 from the results of the survey module's survey. In one embodiment, the current profile comprises a metadata keyword for each device and software element of the IT environment 100. Alternatively, the current profile may include a file and/or a data structure for each device and software element of the IT environment 100.

The business need module 215 identifies a business need 315 for the IT environment 100. In one embodiment, the customer and/or the sales personnel may select the business need from a menu of business needs. Alternatively, the business need module 215 may select the business need from a profile of the customer. For example, the business need may be identified as a function of annual sales, a number of employees, and the like.

The model profile module 220 creates 320 a model profile for the business need. The model profile comprises at least one building block. The building blocks of the model profile may be represented as metadata keywords, files, and/or data structures. In one embodiment, the model profile module 220 stores a model profile for a plurality of business needs. Alternatively, the model profile module 220 may employ an algorithm to create 320 the model profile from the business need and/or business need inputs such as a customer profile.

The recommendation module 225 determines 323 if an additional building block is needed for the current profile so that the IT environment 100 can fulfill the business need. If the recommendation module 225 determines 323 that an additional building block is not needed, the method 300 terminates.

If the recommendation module 225 determines 323 that an additional building block is need, the recommendation module 225 determines 325 a needed building block from the current profile and the model profile. In one embodiment, the recommendation module 225 searches the current profile for each element of the model profile. If an element of the model profile is not found, the recommendation module 225 may flag the element as a needed building block.

The recommendation module 225 further determines 330 if the needed building block is available. In one embodiment, the recommendation module 225 may access a dataset of building blocks. For example, the dataset of building blocks may be a list of metadata keywords for available building blocks. The recommendation module 225 may search the dataset of building blocks for the metadata keyword of each needed building block and determine 330 that the needed building block is available if the metadata keyword for the needed building block is found in the dataset.

If the recommendation module 225 determines 330 that the needed building block is available, the recommendation module 225 recommends 335 the needed building block for the current profile and the method 300 terminates. For example, if a RAID system represented by the keyword “RAID” is needed for the IT environment 100 and available, the recommendation module 225 may recommend 335 the RAID system. The recommendation module 225 may recommend 335 a plurality of needed building blocks.

If the recommendation module 225 determines 330 that the needed building block is not available, the request module 230 requests 340 the development of the needed building block and the method terminates. In one embodiment, the request module 230 records the request in a request dataset. The request dataset may record each request for a needed building block. In addition, the request dataset may prioritize the requests by a number of requests, a type of request, a volume of business represented by each type of request, or the like. The method 300 assesses the IT environment 100 needs and recommends 335 additional building blocks and/or requests 340 the development of building blocks to meet the needs.

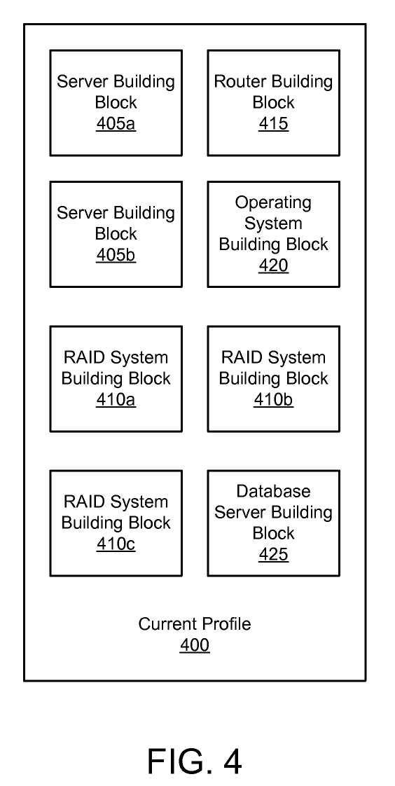

FIG. 4 is a schematic block diagram illustrating one embodiment of a current profile 400 of the present invention. The current profile 400 may be for the IT environment 100 of FIG. 1 and may be exemplary of step 310 of FIG. 3. The description of the current profile 400 refers to elements of FIGS. 1-3, like numbers referring to like elements.

In one embodiment, the survey module 205 surveys 305 the IT environment 100 and the current profile module 210 creates 310 the current profile 100 from the results of the survey module's survey. For example, the agent 235 may detect the servers 130, router 120, and storage subsystems 140 of the IT environment 100 of FIG. 1 by polling each device in the IT environment 100 under the direction of the survey module 205. The agent 235 may further determine the type and model of the servers 130, router 120, and storage subsystems 140. In addition, the agent 235 may determine the type and version of the operating system executing on the servers 130 and may also detect the type and version of middleware running on the servers such as a database server.

The current profile module 210 creates 310 the current profile 400 from the type and model of the servers 130, router 120, and storage subsystems 140 by creating a first and second server building block 405a, 405b, a first, second, and third RAID building block 410a, 410b, 410c, and a router building block 415. In addition, the current profile module 210 may create an operating system building block 420 from the type and version of the operating system and a database server building block 425 for the database server. The building blocks may be configured as metadata keywords, data structures, files, and the like.

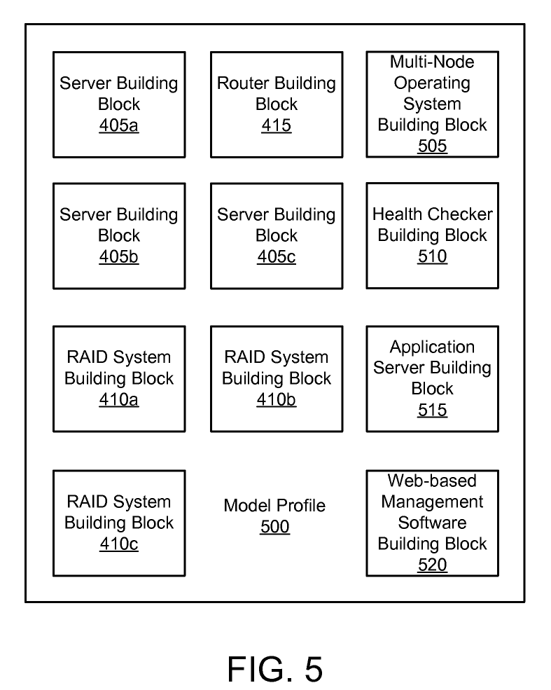

FIG. 5 is a schematic block diagram illustrating one embodiment of a model profile 500 of the present invention and is exemplary of step 320 of FIG. 3. The description of the model profile 500 refers to elements of FIGS. 1-4, like numbers referring to like elements. The model profile module 220 creates 320 the model profile 500 for the business need of the customer.

In the depicted embodiment, the model profile module 220 creates 320 the model profile 500 with three server building blocks 405, three RAID system building blocks 410, one router building block 415, a multi-node operating system building block 505, a health checker building block 510, an application server building block 515, and a web-based management software building block 520 in response to a specified business need. In one embodiment, the model profile module 220 retrieves the building blocks from a dataset that specifies the building blocks for one or more business needs.

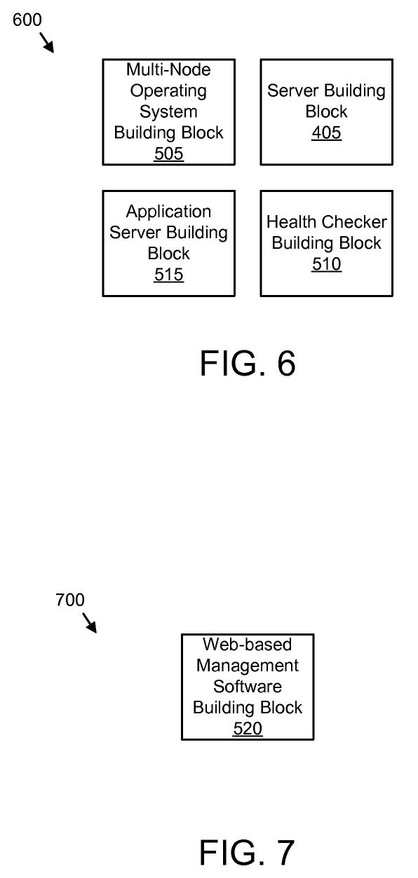

FIG. 6 is a schematic block diagram illustrating one embodiment of recommended building blocks 600 of the present invention. The description of the recommended building blocks 600 refers to elements of FIGS. 1-5, like numbers referring to like elements.

Continuing the example of FIGS. 4 and 5, the recommendation module 225 recommends 335 the multi-node operating system building block 505, health checker building block 510, and application server building block 515 as recommended building blocks 600 because the multi-node operating system building block 505, health checker building block 510, and application server building block 515 are included among the model profile 500 and are available, but are not included in the current profile 400. In one embodiment, the recommended building blocks 600 are organized as a report, a presentation, or the like for communication to the customer and/or the sales personnel.

FIG. 7 is a schematic block diagram illustrating one embodiment of requested building blocks 700 of the present invention. The description of the requested building blocks 700 refers to elements of FIGS. 1-6, like numbers referring to like elements.

Continuing the example of FIGS. 4-6, the request module 230 requests 340 the development of the web-based management software building block 520. In one embodiment, the request module 230 generates a report requesting the development of the web-based management software building block 520. One of skill in the art will recognize that the report may include a plurality of similar requests for building block development.

The embodiment of the present invention assesses IT environment needs. In addition, the present invention recommends building blocks to meet the assessed needs. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to assess information technology (it) environment needs, the apparatus comprising:
a survey module configured to survey an IT environment;
a current profile module configured to create a current profile of the IT environment, the current profile comprising at least one building block;
a business need module configured to identify a business need for the IT environment;
a model profile module configured to create a model profile for the business need, the model profile comprising at least one building block;
a recommendation module configured to recommend at least one needed building block for the current profile from a comparison with the model profile if the at least one needed building block is available; and
a request module configured to request the development of the at least one needed building block if the at least one needed building block is not available.

2. The apparatus of claim 1, wherein the survey module is further configured to survey the IT environment using an agent that polls devices and software in the IT environment.

3. The apparatus of claim 2, wherein the survey module is further configured to survey the IT environment by parsing sales data and service data for the IT environment.

4. The apparatus of claim 1, wherein the model profile module is further configured to aggregate sales data for a plurality of IT environments that are designed for the business need to create the model profile.

5. The apparatus of claim 4, wherein the model profile module is further configured to incorporate market intelligence for products designed for the business need into the model profile.

6. A computer program product comprising a computer useable medium having a computer readable program, wherein the computer readable program when executed on a computer causes the computer to:
survey an IT environment;
create a current profile of the IT environment, the current profile comprising at least one building block;
identify a business need for the IT environment;
create a model profile for the business need, the model profile comprising at least one building block;
recommend at least one needed building block for the current profile from a comparison with the model profile if the at least one needed building block is available; and
request the development of the at least one needed building block if the at least one needed building block is not available.

7. The computer program product of claim 6, wherein the computer readable code is further configured to cause the computer to represent each building block as a metadata keyword.

8. The computer program product of claim 7, wherein the computer readable code is further configured to cause the computer to survey the IT environment by receiving metadata keywords representing the IT environment.

9. The computer program product of claim 6, wherein the computer readable code is further configured to cause the computer to survey the IT environment by polling devices and software in the IT environment.

10. The computer program product of claim 9, wherein an agent polls the IT environment.

11. The computer program product of claim 6, wherein the computer readable code is further configured to cause the computer to survey the IT environment by parsing sales data and service data for the IT environment.

12. The computer program product of claim 6, wherein the computer readable code is further configured to cause the computer to aggregate sales data for a plurality of IT environments that are designed for the business need to create the model profile.

13. The computer program product of claim 12, wherein the computer readable code is further configured to cause the computer to incorporate market intelligence for products designed for the business need into the model profile.

14. The computer program product of claim 12, wherein the computer readable code is further configured to cause the computer to incorporate feedback on the plurality of IT environments into the model profile.

15. The computer program product of claim 6, wherein the current profile and the model profile are configured as Extensible Markup Language files.

16. A system to assess IT environment needs, the system comprising:
an IT system;
a computer in communication with the IT system and comprising
a survey module configured to survey an IT environment for the IT system;
a current profile module configured to create a current profile of the IT environment, the current profile comprising at least one building block;
a business need module configured to identify a business need for the IT environment;
a model profile module configured to create a model profile for the business need, the model profile comprising at least one building block;
a recommendation module configured to recommend at least one needed building block for the current profile from a comparison with the model profile if the at least one needed building block is available; and
a request module configured to request the development of the at least one needed building block if the at least one needed building block is not available.

17. The system of claim 16, wherein the survey module is further configured to survey the IT environment using an agent that polls devices and software in the IT environment.

18. The apparatus of claim 17, wherein the survey module is further configured to survey the IT environment by parsing sales data and service data for the IT environment.

19. The apparatus of claim 16, wherein the model profile module is further configured to aggregate sales data for a plurality of IT environments that are designed for the business need to create the model profile.

20. A method for deploying computer infrastructure, comprising integrating computer-readable code into a computing system, wherein the code in combination with the computing system is capable of performing the following:
surveying an IT environment;
creating a current profile of the IT environment polling devices and software in the IT environment, the current profile comprising at least one building block, wherein each building block is represented as a metadata keyword;
identifying a business need for the IT environment;
creating a model profile for the business need by aggregating sales data for a plurality of IT environments that are designed for the business need, the model profile comprising at least one building block;
incorporating market intelligence for products designed for the business need into the model profile;
recommending at least one needed building block for the current profile from a comparison with the model profile if the at least one needed building block is available; and
requesting the development of the at least one needed building block if the at least one needed building block is not available.
